(19) United States
(12) Patent Application Publication
(10) Pub. No.: US 2007/0281734 A1
(43) Pub. Date: Dec. 6, 2007

(54) Method, system and apparatus for handset screen analysis

(76) Inventor: Yoram Mizrachi, Herzelia (IL)

Correspondence Address: PEARL COHEN ZEDEK LATZER, LLP, 1500 BROADWAY 12TH FLOOR, NEW YORK, NY, 10036, US

(21) Appl. No.: 11/802,415

(22) Filed: May 22, 2007

Related U.S. Application Data
(60) Provisional application No. 60/803,152, filed on May 25, 2006.
(60) Provisional application No. 60/803,157, filed on May 25, 2006.

(51) Int. Cl. H04M 1/00

(52) U.S. Cl. 455/550.1

(57) ABSTRACT

A system, method and apparatus for acquiring and analyzing images from handset displays.

### CROSS-REFERENCE TO RELATED APPLICATIONS

This application claims benefit of U.S. Provisional Patent Applications Ser. No. 60/803,152 entitled “A method for systematic classification of mobile phone screen graphics into multi-layer well-defined objects” and Ser. No. 60/803,157, entitled “Method for abstracting mobile phone operations and display content into a logical, platform free representation” both filed May 25, 2006, the entire contents of which are incorporated herein by reference.

### FIELD OF THE INVENTION

Embodiments of the present invention relate generally to handset testing systems, and in particular, to a method, system and apparatus for automatedly analyzing handset screens.

### BACKGROUND OF THE INVENTION

Manufacturers, operators and/or programmers of handset devices, for example, mobile telephones, palm-top computers, personal digital assistants (PDAs), and other devices having display screens test the manner in which the products display data, text, images, symbols and other information. There is a need for efficient quality testing of handset displays.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 depicts a schematic diagram of a system 100 for testing and/or analyzing an image from a handset display according to embodiments of the present invention;

FIGS. 2A and 2B depict image cropping according to embodiments of the present invention;

FIG. 3 illustrates an example of segmentation of a display screen 300 according to some embodiments of the invention;

FIG. 4 illustrates a schematic diagram of a system for obtaining handset display information in accordance with embodiments of the present invention;

FIGS. 5A and 5B illustrate two handset displays of different sizes and their processing according to embodiments of the present invention;

FIG. 6 depicts a schematic data table according to embodiments of the present invention;

FIGS. 7A, 7B and 7C, which illustrate an example of recognizing an “edit box” GUI element according to embodiments of the present invention;

FIG. 8 depicts a method 800 according to embodiments of the present invention;

FIGS. 9A and 9B depict an illustration of an image and a table of the result of the recognition and parsing method according to embodiments of the present invention; and

FIGS. 10A, 10B and 10C depict an illustration of an image and its analysis according to embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

Some portions of the detailed description which follow are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

Unless explicitly stated, the method embodiments described herein are not constrained to a particular order or sequence. Additionally, some of the described method embodiments or elements thereof can occur or be performed at the same point in time.

Embodiments of the present application describe apparatus and methods for acquiring images displayed on one or more handsets into a host computer and generating an accurate list of basic elements appearing on the handsets. Such a list may be retrieved and/or used by other programs in order to comprehend semantically what objects are displayed on the handset screen.

Methods according to embodiments of the present invention may be based on prerequisite learning of possible basic objects displayed on the handset. This prerequisite learning will be referred in this document as ‘handset template” containing those objects definition.

In some embodiments of the invention, a camera may be used to acquire an image displayed on a handset screen. In some embodiments of the invention, for example, in the code division multiple access (CDMA) environment, use of a camera to acquire the image may not be required, as the image may be received using other standard methods.

Accuracy of recognition, e.g., reduction of false positives, reduction of false negatives, etc., is directly related to the given threshold level for recognition. Thus, for example, the higher the threshold, the more accurate the recognition, and conversely, the lower the threshold, the less accurate the recognition. In the terminology of the present application, the accuracy level may be given, and a threshold may separate between high accuracy objects and low accuracy objects. A higher threshold may reduce the number of false positives but also increase the number of false negatives, e.g., there may be fewer errors, but some of the good results may be removed as well. If a pixel map of an image is provided, a threshold of 100% may be possible; however, in case an image is not matched pixel by pixel, a threshold of 100% may not be practicable. Accordingly, in case the digital source of the images is not provided, for example, where the image is acquired by an external analog-based camera, it may be desirable that the source patterns and the target image both be in the same resolution.

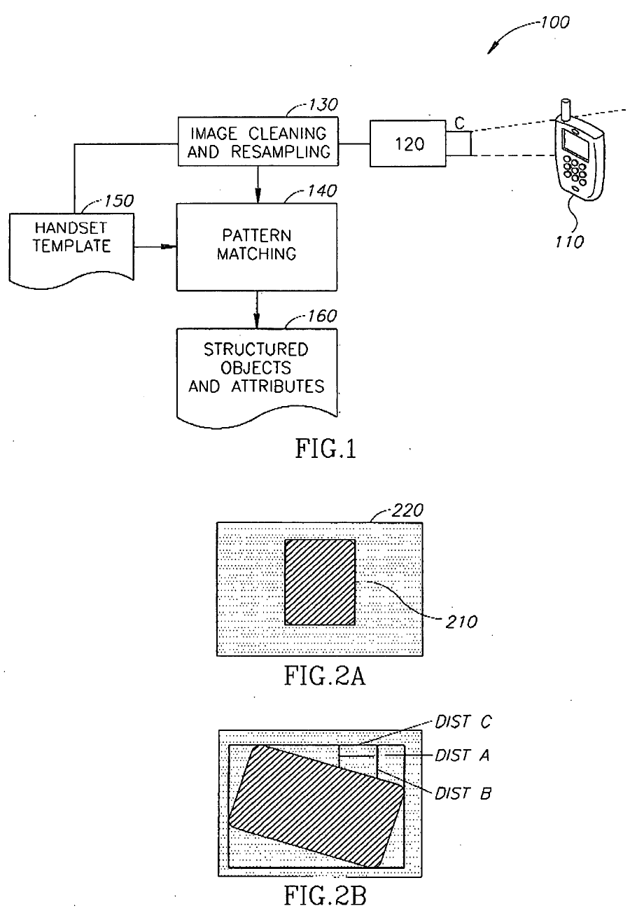

Reference is made to FIG. 1, which depicts a schematic diagram of a system 100 for testing and/or analyzing an image from a handset display according to embodiments of the present invention. Handset 110 may be located in a suitably sterilized environment, for example, having appropriate light conditions and a clear optical path. Handset 110 having display 111 may be placed, for example, in a cradle or other apparatus. Camera 120 may have an image sensor trained on the display 111 of handset 110. Camera 120 may be a CCD camera, a CMOS camera, or any suitable device able to capture and retrieve an image of display 111. Camera 120 may provide the image to an image cleaning and resampling module 130, which may clean, crop and/or re-sample the image. The cleaned image to a pattern matching module 140. Pattern matching may be performed by any suitable method, program or algorithm, as is known in the art. According to embodiments of the present invention, one or both of image cleaning and resampling modules 130 and 140 may utilize or draw upon previously obtained or stored data about the handset located in handset template 150 in order to increase the level of accuracy. The image cleaning and re-sampling module 130 may use the handset template 150, for example, in order to retrieve useful information such as original screen resolution, ratio between acquired pixels to original display pixel, color mapping and other parameters. According to embodiments of the invention, pattern matching module 140 may produce structured objects and attributes 160.

Reference is made to FIG. 2A and 2B, which depict one setting for a handset for ease of image cropping according to embodiments of the present invention. Image cropping may be performed by separating lighted area 210 of handset display from a surrounding darker area 220 and using the blocking square to eliminate unnecessary field of view. The blocking square shown in FIG. 2B may be placed alignment with the entire image. In case of placement of the device at a small angle, measurement may be made in the form of counting pixels on two locations along one of the screen edges inside the blocking square to detect the proper angle correction required.

Accordingly,

dist A=size (in pixels) from blocking square edge to screen edge (lighted area)
dist B=size (in pixels) from blocking square edge to screen edge on different X location (assuming dist A is measured on the Y axes) on the same edge.
dist C=size (in pixels) between dist A and dist B (on the X axis).
dist A and dist B may be measured on the X-axis. Given the above measurements, a simple calculation may be made to obtain the proper angle correction value, for example, arctan((dist A-dist B)/dist C) may provide such a value in radians.

According to embodiments of the invention, once the image is re-sampled, it may be segmented. In some embodiments of the invention, the image may be segmented first using predefined area segmentation and then using an edge detection algorithm to detect major segments. Pattern matching may be performed on each segment. Segmenting the image into a plurality of clear areas of interest, possibly having different characteristics, may reduce complexity and probability for errors and may improve performance of the pattern matching module. Known patterns, for example, characters and icons, may be located in the handset template, and may be compared with the image to produce a list of objects that were matched on the acquired image. Multiple occurrences of the same object is possible. For example, in the text “Hello world” the following objects may be found: one occurrence of each of “H”, “e”, “w”, “r” and “d”; two occurrences of “o”, and three occurrences of “l”. Each matched object may be saved separately with additional information, for example, data relating to type, color, location, size, etc.

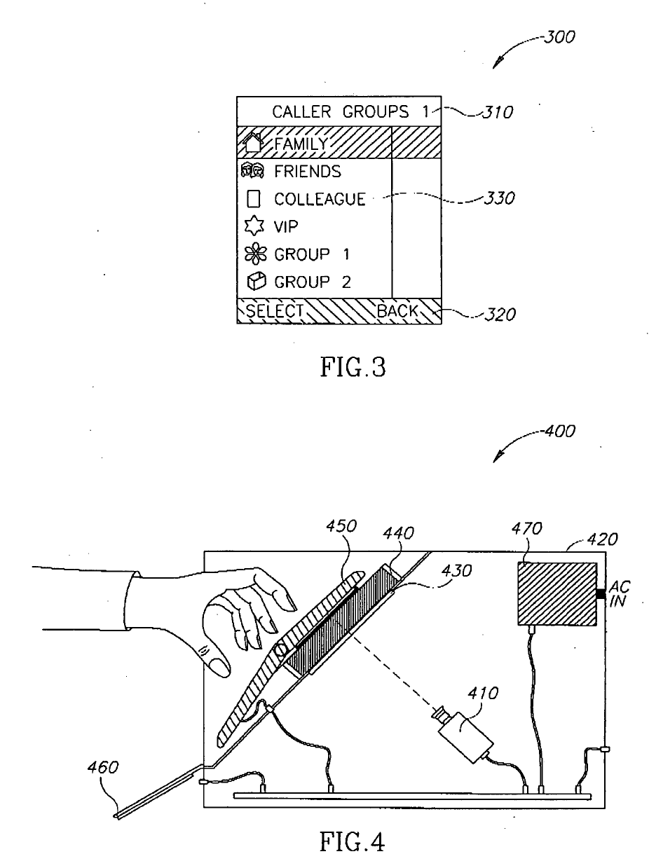

Reference is made to FIG. 3, which illustrates an example of segmentation of a display screen 300 according to some embodiments of the invention. Some screen areas, for example, title area 310 and soft button area 320, may be known, for example, based on a handset template, and may be segmented initially. A remaining portion, for example middle portion 330, may represent the area of items on the screen. The pattern matching process may be instructed not to locate or match objects outside the segmented areas. Given the separation for known areas may allow faster performance, for example, where changes are found or searched particularly at specific section. For example, where changes may be searched or found in the status line of the device, this section only and not the entire screen may be repeatedly scanned rapidly.

According to embodiments of the invention, elements on the screen that are not recognized as letters or text objects may be treated as images. An image may be, for example, any object with a bounding rectangle that is not part of the handset template known objects. Since images do not necessarily answer a known pattern, several rules may be used to group images component together, for example, if the images overlap in their bounding rectangle or their bounding rectangles are proximate.

The output of the process may be a list of all objects as they appear on the screen. This method does not necessarily filter, nor does it necessarily search for specific elements on the screen. According to embodiments of the invention, searching and working with the objects may be done on a non-image level, thereby allowing a flexible approach.

Reference is made to FIG. 4, which illustrates a schematic diagram of a system for obtaining handset display information in accordance with embodiments of the present invention. A camera 410 may be located in a clean cabinet 420. The cabinet 420 may be sufficiently sealed from external light, allowing access to handset 450 by opening a front door panel 460. Front door panel 460 may have on a side outside the cabinet a display, for example, a liquid crystal display (LCD). The camera 410 may face a window 430. On the side of window 430 opposite camera 410 may be a handset cradle 440 in which a handset 450 may be placed display side facing the window. It is noted that embodiments of the present invention may provide for constant distance between camera lens and handset display, allowing for a fixed focus and pixel ratio condition, regardless of the thickness of the handset or its shape, e.g., block, clamshell or slider. It will be noted that for handsets with internal backlit display, no external light is required or used in the optical path. An optional external light may be provided to illuminate cameras without internal backlighting, or when testing camera function without internal backlighting. According to embodiments of the invention, images acquired by camera 410 may be transmitted to a host computer using any standard connection, e.g., Firewire, USB, IEEE 802.3x, Ethernet, IEEE 802.11x, WiFi, BlueTooth, etc. Handset 450 may be connected to a host computer using any connection suitable for providing commands or instructions to the handset, e.g., Firewire, USB, IEEE 802.3x, Ethernet, IEEE 802.11x, WiFi, BlueTooth, etc. Cabinet 420 may be powered by power unit 470. The cabinet may also include software controlled components enabling the physical connection and disconnection of the device to the host computer. Such components may be used for troubleshooting purposes in the course of device testing. Such connection might include USB, Bluetooth, audio, infrared or Wi-Fi connections, etc.

In order to detect screen edges, the system according to embodiments of the invention may use information from the handset template, including, for example, ensuring the display screen is lit at any given moment. A command may be provided to handset to control the handset display, or a simple command may be provided, such as for example, pressing a key that automatically lights the screen. In some embodiments of the invention, for automatic detection of the screen edges, no constant light condition is required. Once detected, the system may set the camera region of interest (ROI) and exact the location of the handset. Beside the decrease in actual image size, this may also result in a more predictable set of results that depend on location on the phone. For example, in order for the pattern recognition module to use the rule that the “new message” indicator may only appear within a given area of the screen, the acquired screen edges should calibrated and aligned, for example, to X=0, Y=0.

In embodiments of the invention, a method may be performed as described below. A condition where the handset screen is lit may be created. A single frame with the full region of interest (ROI) may be captured. One or more threshold functions may be used to detect possible contours. In some cases, analog capturing and imperfect alignment and/or imperfect screen rectangle may prevent 100%. Accordingly, in some embodiments of the invention, only contours that can be bounded to a rectangle with at least a large part, e.g., 95%, fitness may be used, e.g., up to 5% area of the bounded rectangle is not within the contour itself. From the filtered contour, embodiments according to a method of the present invention may use the largest contour which is less then 95% of the entire field-of-view. This may be used to prevent unintended detection of the window.

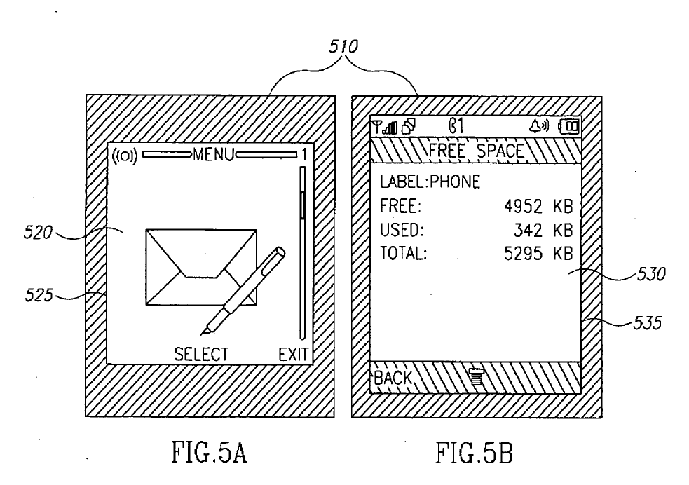

Reference is made to FIGS. 5A and 5B, which illustrate two handset displays of different sizes and their processing according to embodiments of the present invention. The ROI setting process according to embodiments of the present invention may crop each handset display according to its actual lighting condition. Accordingly, region of interest 510 may be cropped at boundary 525 for handset 520 and at boundary 530 for handset 535 based on the contrasted lighting of the handset with the dark background.

According to embodiments of the present invention, the combination of CCD or CMOS based camera which is a pixel matrix based and an acquired handset screen display which is also based on LCD pixel based matrix may require that the acquired image be reprocessed in order to achieve improved recognition and a familiar/constant base-line for analysis. Assuming the acquired image is cropped, e.g., position (0, 0) is aligned with the handset display, a process of scanning the original image and reconstructing the original handset display image may be started.

Image re-sampling and cleaning may involve several iterations and processes. In slight angle correction, the method may correct an image acquired from on a handset facing the camera at an imperfect angle, e.g., more or less than 90 degrees. Accordingly, the image cleaning process may correct for slight angle deviations. In fish-eye correction, the method may correct an image acquired through a wide angle optical configuration. In some embodiments, in order to reduce physical size of the clamping device, the optical path may introduce “fish-eye” phenomenon which may be common to close distance optical acquisition. Embodiments of the invention may correct Moire pattern distortion. In some cases, slight angle error may result in a Moire effect, as may be common when attaching two matrix patterns, e.g., LCD and CMOS. In addition, since CMOS/CCD sensors are analog by nature, they may acquire the light using a certain angle that is not straight, thereby causing the acquisition of neighboring pixels. In addition, since using a color camera which by nature may insert an artificial built-up of the image, e.g., each RGB value is interpolated from its 3×3 neighbors, anti-aliasing correction may be performed on the image. Due to the analog nature of the camera, an output image may include noise. Accordingly, obtaining several samples of the same source and averaging those sample to a single image may result in randomization and therefore reduction of noise.

According to image cleaning and processing methods embodying the present invention, the resolution of the image may be reduced, for example, in order to receive common, non-camera related resolution, and/or, for example, to resolve problems describe above. The identification and combination of at least one, or two or three or four of the above-described effects may enable methods in accordance with the present invention to obtain a suitably workable sample for both the processing section as well as possible quality validations.

A given handset display may contain or be enabled to display several hundred possible objects. According to embodiments of the present invention, these possible objects may be divided into four categories, e.g., characters, icons, graphical user interface (GUI) elements, and images. A learning process according to embodiments of the present invention may be performed by automatic methods, by manual methods, or by a combination of the two. The various categories and their treatment according to embodiments of the present invention are discussed below.

Characters may be categorized as members of a family of fonts, wherein within each family, sizes and attributes, such as italic, bold, underline, etc., may be applied. In general, any format of a character may be a separate object, namely the letter A in each of normal, bold, italic, underline, bold underline, bold underline italic, bold italic, reverse type, etc., may be considered a different object in the system.

It will be noted that although optical character recognition (OCR) methods are known and some OCR products are commercially available, such methods may lack the required speed of analysis, for example, less than 0.5 second for analysis of a display screen. In order to resolve this, a method according to embodiment of the invention may use training and analysis phases. In a training phase, during which speed of recognition may be less important than during normal use, a combination of OCR methods may be used to identify the characters. During the analysis phase, pattern matching techniques with limited learned objects may be used, where several optimization algorithms may be used to accelerate the exact matched pattern.

Since the system may define a set of characters as objects and not as language, new language support is not considered a new level of complexity, as there is no substantial difference at the analysis stage between a Latin character and a Chinese or Japanese character. Once recognized, characters may be identified by at least some of the following attributes: font, size, foreground color, background color and position. It will be recognized that any method may be used to detect characters consistent with embodiments of the present invention, for example, by using learn and match based algorithms or by using OCR based algorithms.

According to embodiments of the present invention, icons may be well-known images that are not alphabetical characters. Typically, each icon may be associated with a special meaning such as “New message”, “Battery indicator”, “Signal strength”, “Search”, “Call in progress”, etc. Icons may be logically grouped based on the meaning of the icon. This grouping can be done as part of icon animation or as part of various icon states.

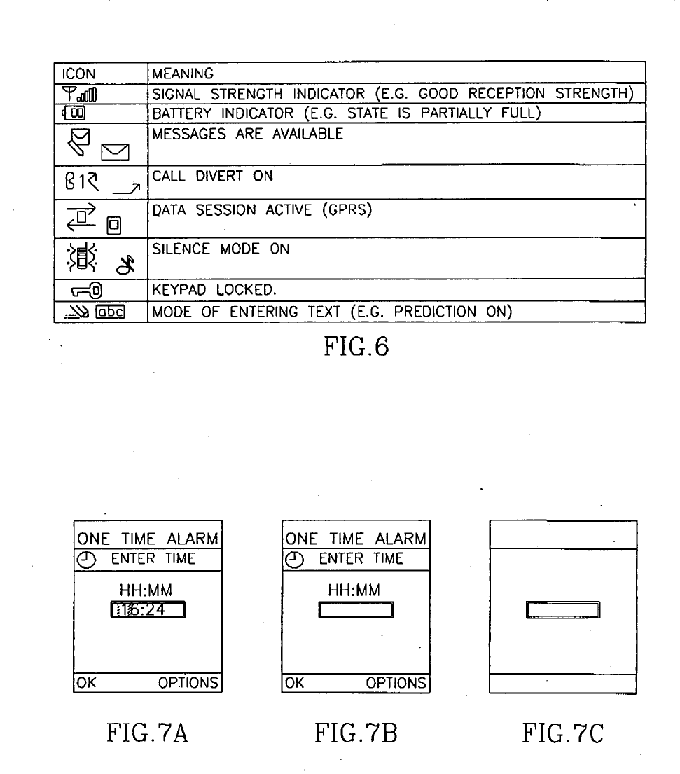

Reference is made to FIG. 6, which depicts a schematic data table according to embodiments of the present invention. One ore more icons and their respective meaning may be associated. Some icons may be associated exclusively as appearing on specific locations on the handset display. This information may be specified in the learning phase and included into the handset template for future use during the analysis phase. A location field may be associated with an icon record, and using location masking, an icon appearing outside its possible region may not be recognized as icon, but rather as an image. Masking icon identification based on location may reduce both analysis time and error rate.

It will be recognized that icons may be actual images having contours less well-defined than characters. Accordingly, it may not be possible to search for an icon on the handset display using contour finding techniques. Rather, according to embodiments of the present invention, pattern matching techniques that include recognition and matching of color and complexity may be used. Methods according to embodiments of the invention may identify well-defined locations, and search for predefined icons in those areas. If recognized, icons may be treated as objects with a possible state. For example, a batter icon may be recognized and its state be empty, full, or a state in between the two, etc.

Graphical user interface (GUI) elements may be considered objects that represent well-known user interface options. Accordingly, GUI elements may be defined by standard matching techniques and/or by semi-matching techniques, and a set of rules. Because GUI elements may exceed an exact bitmap representation, rules may be required to identify them.

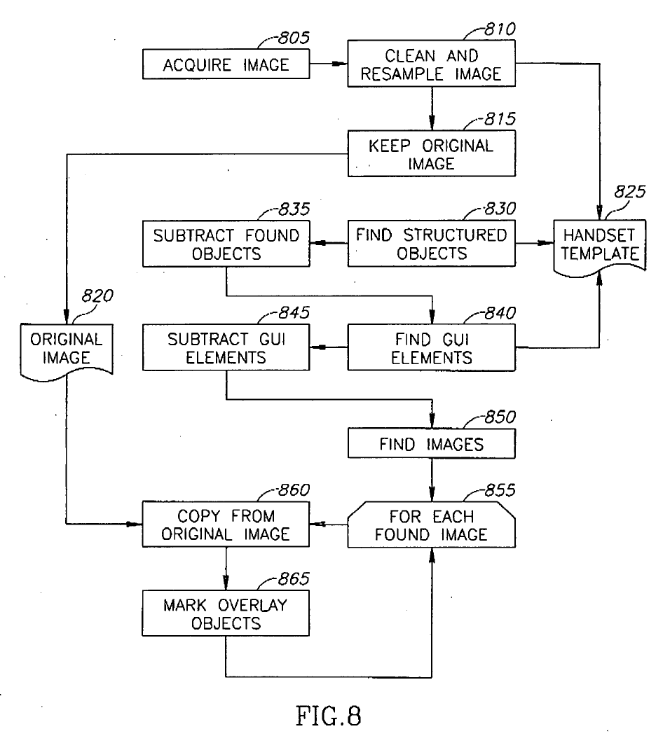

Reference is made to FIGS. 7A, 7B and 7C, which illustrate an example of recognizing an “edit box” GUI element according to embodiments of the present invention. The GUI element may have various sizes and yet be considered an edit box. In FIG. 7A, the numbers may be recognized and subtracted from the image. In FIG. 7B, the text may be recognized and subtracted from the resulting image. Finally, after a number of iterations, the remaining object, for example, the rectangle, may be recognized as a GUI element, for example, by rules specifying the surrounding lines of the edit-box. In embodiments of the present invention, known GUI elements may be edit boxes, radio buttons, pop-up windows, combo box menus, soft buttons, check boxes, scroll-bars, etc. These GUI elements may have recognizable features that may be searched when methods according to the present invention scan the display screen. A popup window might be defined as a thick, e.g. 5 pixels thick, box in a predefined location.

Each known handset in the system may be associated with a handset template. During run-time conditions, for example, during display screen analysis, the handset template may used as the source for all detected objects for the screen being analyzed. In order to receive under-layer objects, for example, edit-boxes or pop-up windows, and non-structured objects such as images, the analysis may be performed in several passes or iterations, wherein each phase removes or subtracts from the image the matched object from the acquired image, thereby allowing the next pass or iteration to identify the successive lower layer objects. The remaining or last elements to be identified may be deduced to be non-structured objects, such as images or video objects. These objects may be treated using blob-based detection algorithms in order to define their borders on the screen. When an image is detected, the image may then be taken from the original acquired image, e.g., the image before subtraction. All objects having a location, e.g., as identified by (X, Y, object size), overlaying the image may be marked as a suspected part of image. Such objects might also increase the size of the identified image, for example, if an image was detected up to location X and an object was located in location X−2 with size of 5, the size of X will be changed to X+3.

Several thousands objects may be matched; however, according to embodiments of the present invention, the image processing time should be reduced as far as possible, for example, to less than 500 milliseconds, matching optimization techniques may be used according to the below guidelines.

First, some elements may be located only on specific segments of the screen, for example, the battery indicator can be only matched in specific region, per each specific phone; soft button text may be located in specific locations; etc. When recognizing objects in any specific region according to embodiments of the present invention, objects that cannot be found in that region may not be searched.

Seaching in only predefined section, where changes are looked reduces processing time.

The result of the pattern matching process according to embodiments of the invention may be a list of available objects as they appear on the screen, including type, content, location, size, state, and other parameters. The may contain reference to each specific object in the handset template, and additional attributes as described.

Reference is made to FIG. 8, which depicts a method 800 according to embodiments of the present invention. It will be recognized that the method may implemented to be performed by any form of computer software, firmware, hardware, etc. An image may be acquired (805). The image may be cleaned and resampled (810). The original image may be kept or stored in memory for later use (815, 820). Characters may be associated into recognized words and/or functions based on the handset template (825). Structured objects may be located in the resulting image (830) and subtracted (835). GUI elements may be found in the resulting image (840) and subtracted (845). Images may be found (850), and for each image (855), on a copy made of the original image (860), the method may mark overlay objects (865).

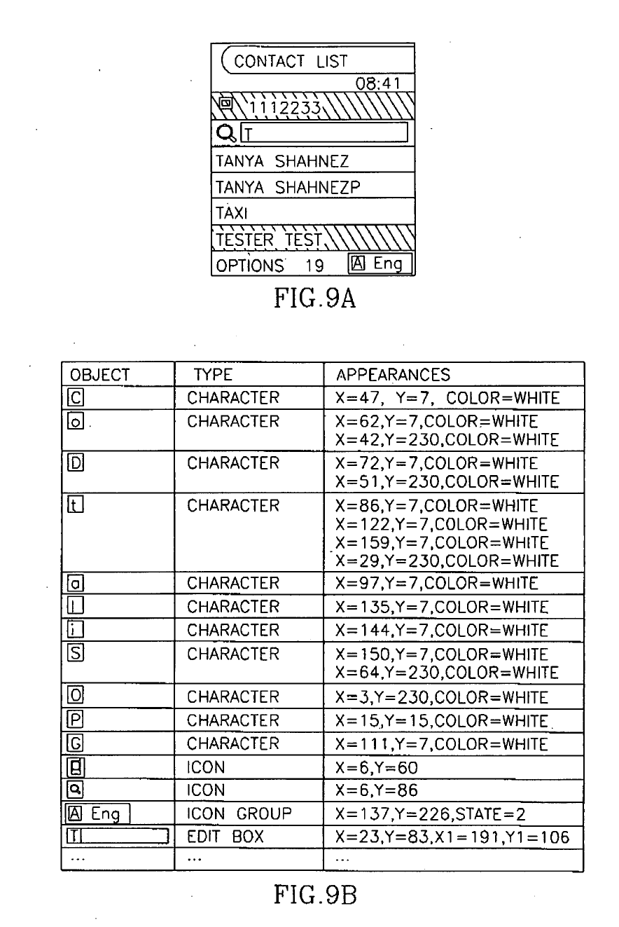

Reference is made to FIGS. 9A and 9B, which depict an illustration of an image and a table of the result of the recognition and parsing method according to embodiments of the present invention. The structured objects may be extracted from the image and associated with type and appearance, where appearance may include location, color, state, and/or other attributes.

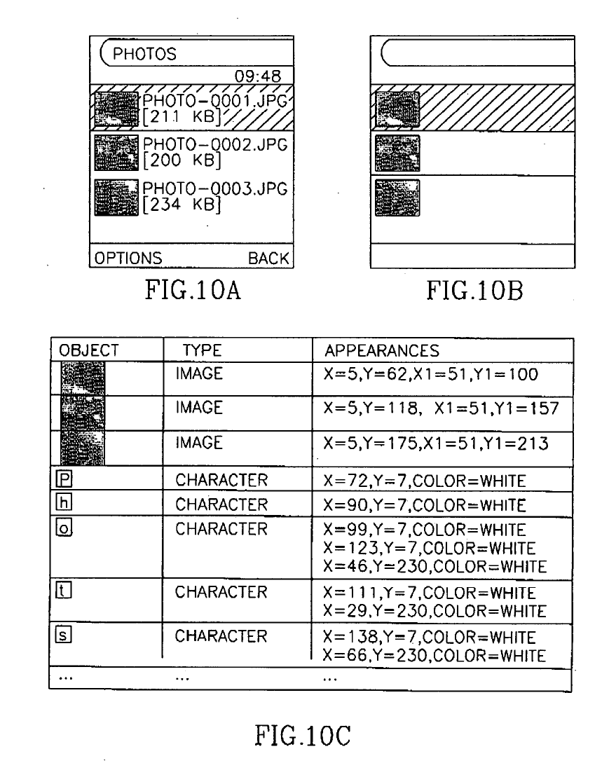

Reference is made to FIGS. 10A, 10B and 10C, which depict an illustration of an image and its analysis according to embodiments of the present invention. FIG. 10A depicts an image acquired from a handset display. After a first pass, for example, as depicted in the method described above, all structured objects may be subtracted from the original image, leaving the image of FIG. 10B, which may be analyzed using a blob-like detection task to identify the three remaining non-structured images. The results of the analysis may be stored in a data table as depicted in FIG. 10C.

It will be recognized that different displays may represent colors in different methods and values. Colors values, whether in red, green, blue (RGB) or hue, saturation, value (HSV) color space, may therefore receive different values on different handsets. Accordingly, an original image may appear differently on the handset display screen. Although for human eyes, the images may have the same colors, their color space values may be different. The proposed system may handle such differences, for example, by first treating only basic colors as colors and accepting a certain level of variance when comparing colors. Handset template may include additional information to help detecting known colors. For example, a color in a template for a handset type may be associated with a particular range of HSV color space values.

As described above, images may be considered the default object type for any unmatched object. Images may be recognized in a second or subsequent pass on the image. The same detection mode may also be used for video. The blob detection may be processed starting from the display edges.

Some elements on the handset display may be animated, for example, in repeating animation sequences, or may have a predefined number of states. Individual members of animated or state icons may be grouped according to embodiments of the present invention into groups with the same meaning, e.g. battery, message, etc., where the specific icon may (in case of state) represent the state of the group (e.g. battery-full).

A video object may be considered to be different from other types of objects. Each frame of a video may be considered an image object. For example, by default the system and method may process one acquired image at a time, which may not suffice to handle the required performance for video. Accordingly, a method in accordance with the invention may request video capture of a specific image object recognized in the first frame, identified as an image on the screen. The video capture may then be analyzed, for example compared to the source video, or analyzed based on performance parameters.

The human eye may immediately recognize an item selected or highlighted in a list. One method and system for identifying a selected entry includes: (a) from the analyzed screen, detect similar attributes entries (e.g. start on the same Y location), to filter out the “Mode” or “Colours” in the above example; (b) from all items in the list, identify the most significant change in foreground and background; and (c) when not certain, e.g., if none or two are selected, enter a keyboard movement, e.g., up and then down, or the handset screen, to detect changes, and based on the key direction, identify focused entry.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A method of analyzing an image obtained from a handset display comprising:
acquiring an image from a handset display;
matching known patterns to portions of said acquired image based on one of a plurality of handset templates; and
storing attributes of matched patterns.

2. The method of claim 1, wherein stored attributes of said matched patterns include at least one attribute selected from the group consisting of identity, object type, location, color, and font of said structured object.

3. The method of claim 1,
wherein at least of said known patterns comprise structured objects,
wherein said handset templates include an expected attribute for at least some structured objects, and
wherein matching known patterns of structured objects to portions of said acquired image comprises matching a subset of known patterns having an expected attribute corresponding to an attribute of said portion of the acquired image.

4. The method of claim 3, wherein said expected attribute is location.

5. The method of claim 3, wherein said expected attribute is color of said structured object.

6. The method of claim 3, wherein said expected attribute is font of said structured object.

7. The method of claim 1, wherein matching known patterns to portions of said acquired image comprises:
identifying at least one structured object;
subtracting said identified structured object from the image;
iterating said steps of identifying and subtracting until no further structured objects remain in said image; and
storing at least a portion of remaining objects as images.

8. A system for testing a handset having a display comprising:
a camera capable of being aimed at said handset;
a handset cradle to attach the handset with the display facing said camera;
a handset connector to be attached to a data port of the handset; and
a processor to provide instructions to said handset, to operate said camera to acquire images of the handset display, and to analyze said acquired images.

9. The system of claim 8, further comprising a cabinet containing said window, said handset cradle, said camera and said handset connector, and further containing a front door panel, wherein said front door panel is capable of being opened to provide access to said handset cradle, and capable of being closed to prevent light from entering said cabinet.

10. The system of claim 8, further comprising camera communication means for communicating data between said camera and said processor.

11. The system of claim 8, wherein said processor is further to manage connections of said handset to the processor by connecting or disconnecting said handset.

12. The system of claim 8, further comprising a peripheral device capable of connecting to said handset, and wherein said processor is further to manage connections of said handset to the peripheral device by connecting or disconnecting said peripheral device and said handset.
